(19) United States
(12) Patent Application Publication
(10) Pub. No.: US 2009/0265605 A1
(43) Pub. Date: Oct. 22, 2009

(54) FIXED-FORM INFORMATION MANAGEMENT SYSTEM, METHOD FOR MANAGING FIXED-FORM INFORMATION, AND COMPUTER READABLE MEDIUM

(75) Inventor: Kazushi KANESHIRO, Kawasaki-shi (JP)

Correspondence Address: SUGHRUE-265550, 2100 PENNSYLVANIA AVE. NW, WASHINGTON, DC, 20037-3213, US

(73) Assignee: Fuji Xerox Co., Ltd., Tokyo (JP)

(21) Appl. No.: 12/272,838

(22) Filed: Nov. 18, 2008

(30) Foreign Application Priority Data
Apr. 22, 2008 (JP) 2008-110942

(51) Int. Cl. G06F 17/00

(52) U.S. Cl. 715/221

(57) ABSTRACT

A fixed-form information management system includes: an image input unit that captures an image of a document; a fixed-form recognition unit that recognizes a fixed-form type and an information structure of the document from the image captured by the image input unit; a comparison unit that compares the information structure of the fixed-form type recognized by the fixed-form recognition unit with information structure of a fixed-form type corresponding to the recognized fixed-form type and registered in advance; and a display unit that displays a result of the comparison by the comparison unit on a screen.

### CROSS-REFERENCE TO RELATED APPLICATIONS

This application is based on and claims priority under 35 U.S.C. 119 from Japanese Patent Application No. 2008-110942 filed Apr. 22, 2008.

### BACKGROUND

1. Technical Field

The present invention relates to a fixed-form information management system, a method for managing fixed-form information, and a computer readable medium which recognize a fixed-form type of the captured document, and make association with information structure of a fixed-form type registered in advance.

2. Related Art

Heretofore, data input to a system using a fixed-form document has been developed as commodities in document solution. Most of these commodities have an assumption that the latest version is used as fixed-form type (form) to be used. In case that data is registered in an old version fixed-form document, an error is frequently produced on its system. The role of the form is merely data input to the system.

This form, once it is defined, can be outputted as printing matters such as paper documents in large quantities. Further, owing to contact omission of the updated version form or user's carelessness, it is not ensured that data is always input in the latest version form.

In case that the form is a contract or an approval document, the form document of which an image is to be read (scanned) can be put on a work flow as it is. In this case, in order to prevent the above problem from being produced, it is necessary for the user to acquire a new form and input the data in the new form again.

### SUMMARY

According to an aspect of the present invention, a fixed-form information management system includes: an image input unit that captures an image of a document; a fixed-form recognition unit that recognizes a fixed-form type and an information structure of the document from the image captured by the image input unit; a comparison unit that compares the information structure of the fixed-form type recognized by the fixed-form recognition unit with information structure of a fixed-form type corresponding to the recognized fixed-form type and registered in advance; and a display unit that displays a result of the comparison by the comparison unit on a screen.

### BRIEF DESCRIPTION OF THE DRAWINGS

Exemplary embodiment of the present invention will be described in detail based on the following figures, wherein:

FIG. 1 is a block diagram explaining configuration of a fixed-form information management system according to an embodiment;

FIG. 2 is a flowchart explaining flow of a fixed-form information management program according to the embodiment;

FIG. 3 is a schematic diagram explaining a concrete example of flow of processing by the fixed-form information management system or the fixed-form information management program in the embodiment;

FIG. 4 is a diagram showing an example of configuration map data;

FIG. 5 is a diagram showing an example of a version addition/change screen;

FIG. 6 is a diagram showing an example of a user display/confirmation screen;

FIG. 7 is a diagram showing an example of a screen for performing mapping of components; and

FIG. 8 is a diagram showing an example of a screen for component selection from an old version.

### DETAILED DESCRIPTION

An embodiment of the invention will be described below with reference to drawings.

### (System Configuration)

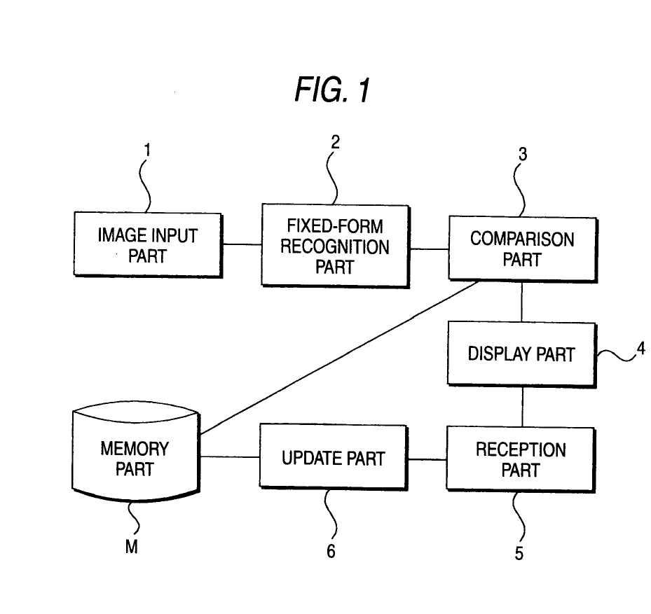

FIG. 1 is a block diagram for explaining configuration of a fixed-form information management system according to the embodiment. The fixed-form information management system according to the embodiment includes an image input part 1, a fixed-form recognition part 2, a comparison part 3, and a display part 4. Further, the fixed-form information management system according to the embodiment includes, in addition to the above components, a reception part 5 and an update part 6.

The image input part 1 captures an image of a document. The image input part 1 is, for example, an image reading unit (scanner) which reads an image of an original document and converts its image to electronic information, or a means which captures an image read by an external image reading unit through a line. In the embodiment, a fixed-form document is captured by the image input part 1, and data written in the fixed-form document is extracted to handle the fixed-form document as electronic information. Here, the fixed-form document means a document in which entry areas are provided in predetermined positions, and component elements (items) are associated with the positions of the entry areas.

The fixed-form recognition part 2 recognizes a fixed-form type and information structure of the document from the document captured by the image input part 1. The fixed-form recognition part 2 recognizes, for example, identification information included in the image and judges the fixed-form type (type of fixed-form) of the captured document. Further, the fixed-form recognition part 2 recognizes information structure (form) of the fixed-form type on the basis on the image. The fixed-form recognition part 2 recognizes, for example, an entry frame of the information included in the image by image processing, and recognizes center coordinates (X and Y-coordinates from the predetermined base position) of the entry frame and a size (sizes in the X and Y directions) of the entry frame.

The comparison part 3 compares the information structure of the fixed-form type recognized by the form recognition part 2 with information structure of the fixed-form type corresponding to this recognized fixed-form type and registered in a memory part M in advance. The memory part M stores therein information structure in the latest version corresponding to the predetermined fixed-form type. The information structure means structure of information associating an item of an entry frame corresponding to each fixed-form type with center coordinates and size of its entry frame. The comparison part 3 compares the information structure of the fixed-form type recognized by the form recognition part 2 with the information structure of, for example, the latest version fixed-form type corresponding to this recognized fixed-form type and registered in the memory part M in advance.

The display part 4 displays a result of the comparison made by the comparison part 3 on a screen (monitor). In this embodiment, the information structure of the fixed-form type recognized by the form recognition part 2 on the basis of the image inputted by the image input part 1, and information structure in the latest version corresponding to this fixed-form type and registered in the memory part M in advance can be displayed on the screen in a contrastable manner.

The reception part 5 receives an instruction from a user. The reception part 5 receives an instruction inputted through, for example, a touch panel or a button provided on the screen (monitor) by the user. In the embodiment, on the basis of the above comparison result displayed on the screen (monitor) by the display part 4, user's instruction of updating the information structure according to the fixed-form type is received by the reception part 5 and reflected.

The update part 6 updates, in accordance with the instruction received by the reception part 5, association between the information structure of the fixed-form type recognized by the fixed-form recognition part 2 and the information structure of the fixed-form type corresponding to this recognized fixed-form type and registered in the memory part M in advance.

In the fixed-form information management system in the embodiment having such the configuration, the following functions can be implemented.

### (First Function)

Function of reading, on the basis of the fixed-form type recognized from the read document, information structure of the latest version fixed-form type corresponding to this fixed-form type from the memory part M, and displaying the read information structure on the screen (monitor) together with the information structure of the recognized fixed-form type.

### (Second Function)

Function of extracting, in case that the version of the recognized fixed-form type is not the latest one but old, information written for each of components existing in the old version information structure (form), and reflecting its information on the new version information structure (form) automatically, or on a location specified by the user.

Namely, the fixed-form information management system has, for each version of the fixed-form type, a file (structure map data described later) in which a relation in each component of the form between versions before and after its version is written, whereby it is possible to convert the form to the latest version form from any version form, and the latest version form on which data has been reflected as the latest version fixed-form document remains. Further, the fixed-form information management system has also a function capable of, on the basis of the user's instruction, inputting/changing the components deleted or added between the versions.

Regarding the respective parts of the fixed-form information management system in the embodiment, all the parts may be realized in one system (for example, multifunctional machine), or a part of them may be provided in a separate system.

### (Fixed-Form Information Management Program)

A fixed-form information management program according to the embodiment is executed by a computer in the fixed-form information management system or a general computer. The fixed-form information management program is implemented in a form installed in a memory portion in the computer, in a form stored in a memory medium such as CD-ROM or DVD-ROM, or in a form delivered through a line such as the Internet or an intranet.

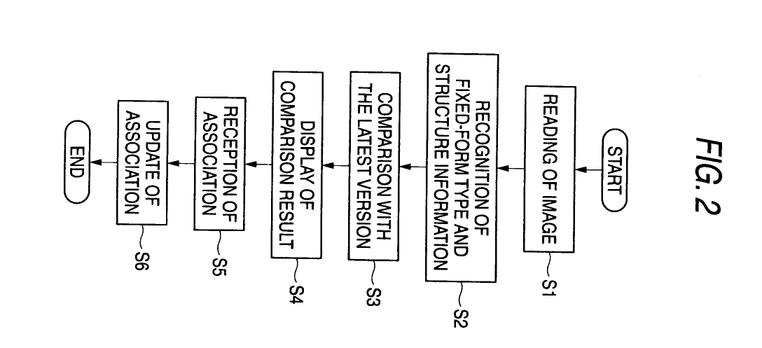

FIG. 2 is a flowchart explaining a flow of the fixed-form information management program according to the embodiment. The fixed-form information management program, firstly, executes a step S1 of capturing a document image. Next, the fixed-form information management program executes a step S2 of recognizing a fixed-form type and information structure of the document from the captured image.

Next, the fixed-form information management program executes a step S3 of comparing the information structure of the recognized fixed-form type with the latest version information structure of the fixed-form type corresponding to this recognized fixed-form type and registered in advance, and thereafter executes a step S4 of displaying a result of this comparison on a screen.

Further, the fixed-form information management program executes a step S5 of receiving an instruction from a user. Thereafter, the fixed-form information management program executes a step S6 of, in accordance with this received instruction, updating association between the information structure of the recognized fixed-form type and the information structure of the fixed-form type corresponding to this recognized fixed-form type and registered in advance.

### (Outline of Flow of Processing)

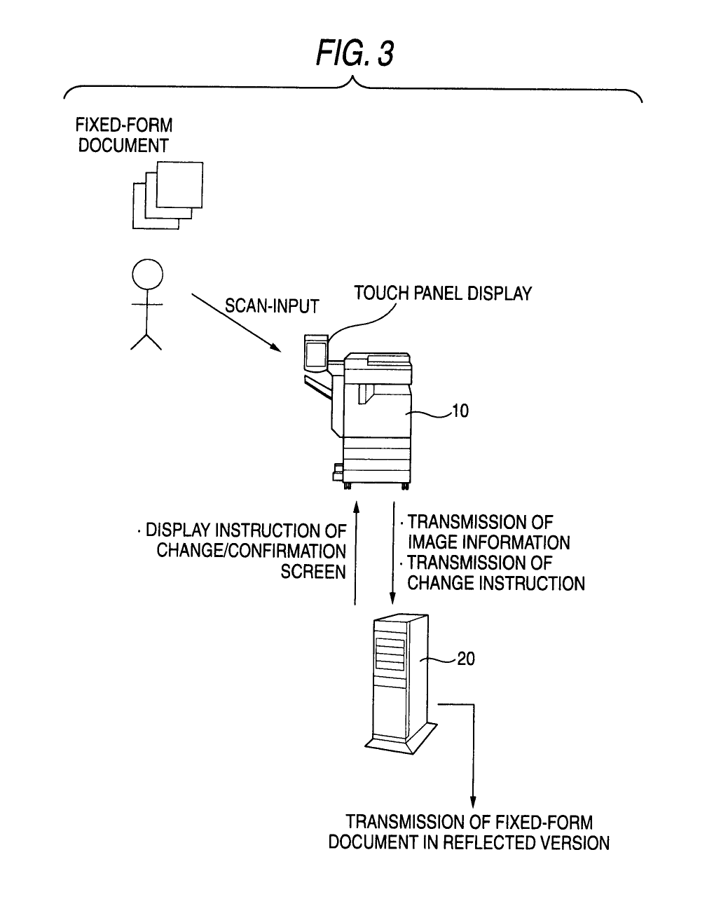

FIG. 3 is a schematic diagram explaining a concrete example of flow of processing by the fixed-form information management system or the fixed-form information management program in the embodiment. In FIG. 3, the fixed-form information management system includes a multifunctional machine 10 and a fixed-form information management server 20; a scanner function of the multifunctional machine 10 becomes the image input part 1, and a touch panel display of the multifunctional machine 10 becomes a processing unit for the display part 4 and the reception part 5; and the fixed-form recognition part 2, the comparison part 3, the update part 6 and the memory part M are provided in the fixed-form information management server 20.

First, image information of a fixed-form document whose version is managed (for example, a contract or a ledger sheet) in which data is written by a person or by printing is read by the scanner function (image input part 1) of the multifunctional machine 10. The image information obtained by this reading is transmitted through a predetermined line from the multifunctional machine 10 to the fixed-form information management server 20.

The fixed-form information management server 20 acquires, from the image information transmitted from the multifunctional machine 10, a fixed-form type and version information of the read document, and confirms whether this version information is the latest version. This confirmation is performed by the comparison part 3 of the fixed-form information management server 20.

In result of the confirmation, in case that the fixed-form type of the read document is in the latest version, the server 20 transmits data of its document, without changing the format of the data, to a unit (not shown) storing the fixed-form document as it is. On the other hand, in case that the fixed-form type of the read document is not in the latest version, the server 20 acquires a configuration map file having correlation information of information structure (form configuration) between the version of the inputted fixed-form document and the latest version of its fixed-form document; extracts, in accordance with a mapping file for each component in its form, the data written in the form from the image information of the inputted old version fixed-form document; and reflects this extracted data onto the corresponding component in the latest version.

At this time, in case that a version hierarchy is in a multistage manner, the server 20 acquires configuration map files in the respective versions, and merges them together, thereby to create mapping information of components between the inputted version and the latest version.

At this time, the server 20 lets the touch panel display of the multifunctional machine 10 display thereon a fact of converting the old version to the latest version, whereby it is possible to confirm how the component in the old version is converted into a component in the latest version.

Further, in case that the user can confirm from this display that unintended conversion is performed, a mapping destination can be changed by an instruction operation by means of the touch panel display. Also in case that there is the necessary component in the new version, the data can be assigned to its component by the instruction operation on the touch panel display. Thereafter, the server 20 transmits the automatically converted data as it is, or transmits the data confirmed by the user to a unit (not shown) storing data as the latest version fixed-form document on which data has been reflected.

Further, in case that many changes of the mapping file continue, the created mapping file can be unsuitable. In this case, a fact that the changes of the mapping file have been made may be informed to a mapping creation manager.

Further, the management of the mapping file may be performed by each user. In this case, the mapping information changed by the user is managed by each user and stored, whereby the mapping information changed by the user can be seen in the next utilization.

### (Concrete Configuration and Example of Processing)

Necessary components are as follows.

(1) A program in a system of scanning and inputting an image of a fixed-form document of which the version is managed and in which data has been written, which confirms whether the fixed-form document inputted at the present is created on the basis of the latest version fixed-form document; finally establishes, in case that the present fixed-form document is in the latest version, the present fixed-form document as data as it is; and extracts, in case that the present fixed-form document is not in the latest version, inputted data other than the information structure (form information) from the old version fixed-form document, thereby to reflect its extracted data onto the latest version fixed-form document.
(2) In the program (1), a function of: in case that the scanned and inputted fixed-form document is in the old version, referring to configuration map data indicating the relation between the information structure (form) of the scanned and inputted fixed-form document and information structure (form) in the latest version; extracting the data from the old version fixed-form document; and mapping and reflecting its data onto the corresponding component in the latest version.
(3) In the program (2), a function of: when the information structure in the old version is associated with the information structure in the new version, displaying which component in the new version each component of the information structure in the old version is associated with, on screen.
(4) In the program (2), a function of: in case that the inputted fixed-form document is in a version before two or more generations, referring to the aforesaid configuration map data and creating configuration map data in the latest version from the version data before two ore more generations.
(5) In the program (1), a function of: extracting data written in the document from the image information of the old version fixed-form document; and displaying a screen showing a state where its data is reflected onto the corresponding component of the new version fixed-form document, thereby to permit the user to confirm the reflected state.
(6) A function capable of shifting the confirmation screen of (5) to a change screen in case that the conversion destination is not the intended destination, or in case that data to be reflected is omitted from the configuration map data, and capable of correcting or adding origin of conversion/destination of change on the change screen.
(7) In (5), a function capable of adding, also in case that a component necessary for the new version fixed-form document has not been input, its component on the displayed screen.
(8) In (6), a function of informing a mapping manager, when the changing function is used times over the determined number, about its fact.
(9) In (6), a function of managing the changed mapping information for each user and capable of user's referring to the changed mapping information from the next time on.

An example of a system implementing the above respective functions is as follows. Namely, the system includes a multifunctional machine 10 (having at least a scanning function and preferably mounted with a touch panel display), and a fixed-form information management server 20 having a function of managing versions of the fixed-form document and a function of storing data.

In such the system, in flow of work handling the fixed-form document, the scanned and inputted data of the fixed-form document is sequentially applied to the work. On the assumption of such the system, an example of flow of processing will be described below.

First, the user writes necessary data in an old version fixed-form document which has been already printed, and an image of the document is captured by a scanner of the multifunctional machine 10. Further, through a line, the image of the fixed-form document may be read. The multifunctional machine 10 transmits this image information to the fixed-form information management server 20.

The fixed-form information management server 20 sends the received image information of the fixed-form document to the fixed-form recognition part 2, acquires identification information and version information of the fixed-form document there, and confirms whether the fixed-form document scanned and inputted by the multifunctional machine 10 is the latest version fixed-form document or not.

As a method of confirming the version of the fixed-form document, there is, for example, a method using the identification information extracted from the image information of the fixed-form document. For example, identification information is assigned to each version of the fixed-form document, and the same type of fixed-form documents are formed into a group. Hereby, version management can be performed in the same types of fixed-form documents. Further, the server 20, after recognizing the identification information, acquires information structure (form) associated with its identification information, and develops its form.

Here, in case that the scanned and inputted fixed-form document is not the latest version fixed-form document, the server 20 confirms, at the comparison part 3, finite difference between the information structure (form) of the inputted fixed-form document and the latest version information structure (form) of the same fixed-form type obtained from the identification information of the fixed-form document. Thereafter, the server 20 acquires configuration map data corresponding to only its finite difference.

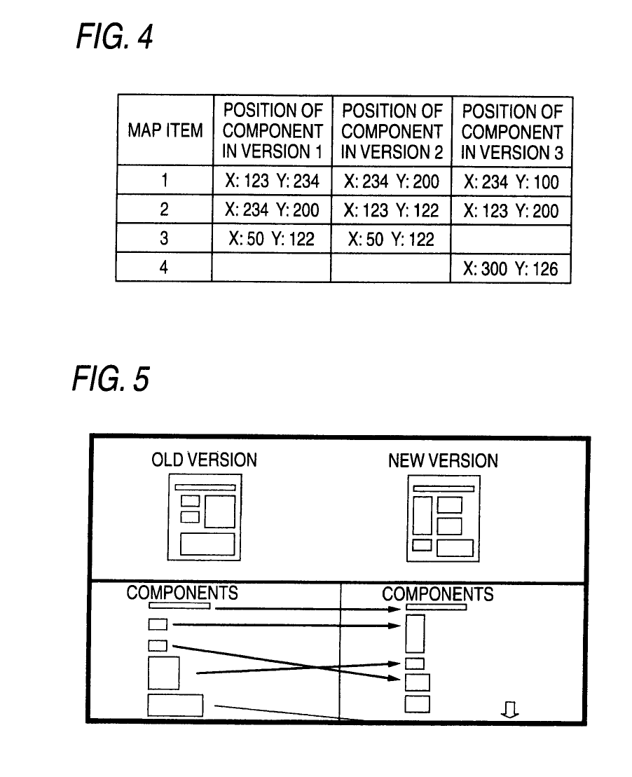

Next, the server 20 merges the acquired configuration map data, and acquires configuration map data to the latest version from the version of the inputted fixed-form document. As the configuration map data, an example as shown in FIG. 4 is thought.

The configuration map data is composed of positional information in each version corresponding to each map item (component). As an example of the positional information, there are X and Y coordinates which show vectors from a base point determined on the fixed-form document to a center of the component. In order to recognize the component, a method of recognizing an area of a minimum unit including this center point is thought. Further, as another method, a method of taking mapping by a subject of the component is thought.

In the example shown in FIG. 4, the latest version is a version 3. Here, map items 1 and 2 are associated with positions in all the versions 1 to 3. On the other hand, though a map item 3 exists as a component in the versions 1 and 2, it is deleted from the components in the version 3. Further, though a map item 4 is not included as a component in the versions 1 and 2, it is added as a component in the latest version 3.

Thus, the configuration map data corresponds also to what is not included in the new version (what is deleted) or what is not included in the old version (what is added).

The map item 3 does not exist on the latest version fixed-form document. At this time, since its fact is displayed on the user confirmation screen, the user can confirm its fact, and the user confirmation screen is shifted to the change screen if necessary, whereby the data of the map item 3 can be reflected in an arbitrary location on the version 3.

The map item 4 exists on only the latest version document. At this time, the map item 4 is recognized as enterable data in the new version, and the user can input directly the data through the user confirmation screen if necessary. Further, in case that its component is necessary data, the input of its data is urged by the user confirmation screen.

As described in the above example, on the basis of the acquired configuration map data, the component data is extracted from the inputted fixed-form document, and it is reflected on the latest version as the corresponding component data.

The data of the inputted fixed-form document reflected onto the component in the latest version is displayed on the tough panel display or printed out. By printing its data, it can be informed to the user that the latest form exists, and also its data can be managed as a log. Therefore, even in case that a problem arises later, the user can readily refer to the input data to the system. Further, the latest version fixed-form document in which there is no data may be printed. Hereby a blank form of the latest version fixed-form document can be acquired.

After update of the version, the manager adds the updated version to the version management function. At this time, component mapping information from the old version to the latest version is created, and as an example of screen display of its mapping information, the following is thought.

### (Example of Display)

FIG. 5 is a diagram showing an example of a version addition/change screen. In an upper section in this screen display, the left side shows a layout of the inputted fixed-form document in the old version, and the right side shows is a layout of a new version fixed-form document corresponding to its inputted fixed-form document. Further, in a lower section in this screen display, components in the respective version fixed-form documents are displayed in decomposition. An arrow in the figure shows a relation in each component. The left and right components connected by the arrow are components associated between the old version and the new version. When a new version is registered, work of associating the components between the old version and the new version is performed.

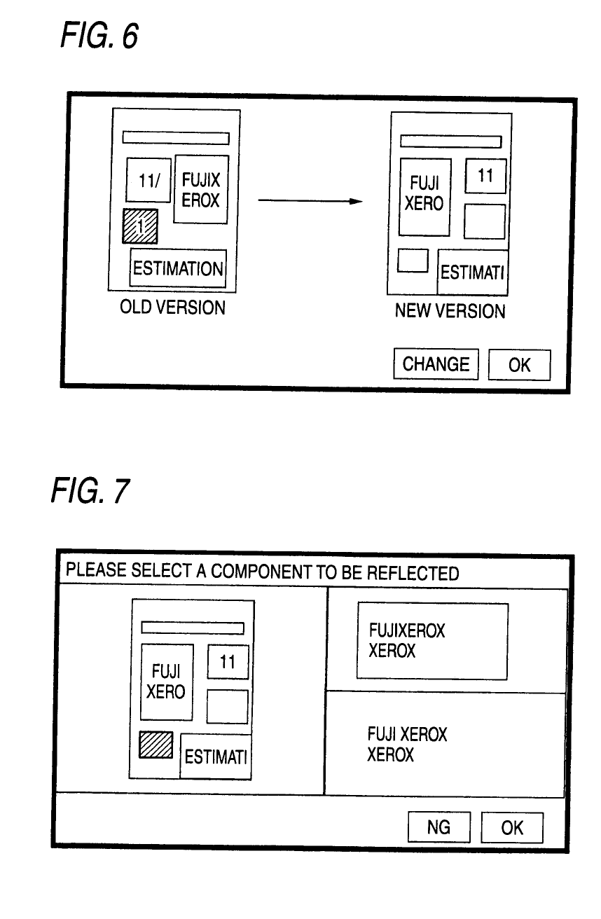

FIG. 6 is a diagram showing an example of a user display/confirmation screen. In this screen display, the components and the layout of the inputted fixed-form document in the old version are displayed on the left side, and the new version components and layout of this fixed-form document are displayed on the right side. The components in the old and new versions are displayed in a state where data has been already reflected thereon. At this time, though the components in the new version correspond to the components in the old version, in case that a format of data to be input is changed (for example, in case that digit number of data to be input is changed), a fact that the format of the data to be input is changed may be displayed so that the user can understand its fact.

A “change” button displayed on a right lower portion in the screen is a button selected when mapping of the components is changed. As this “change” button is pressed, the screen is shifted to the display screen shown in FIG. 5. An “OK” button is a button for decision when mapping is decided.

In case that there is the before-described component which does not exist in the new version but exists in the old version, its component is displayed on the old version layout, distinguished from other components so that the user can notice its component. In the example shown in FIG. 6, its component is subjected to hatching, and actually displayed in color such as red semi-transparent color which the user can readily notice. In case that the user selects this component, the screen display is shifted to a screen (refer to FIG. 7) for determining which component on the new version this component is mapped onto.

FIG. 7 is a diagram showing an example of a screen for performing mapping of the component. On the left side in this screen example, a layout of a new version component group is displayed. The user, from this layout, selects a new version component to be associated with the component which exists in only the old version document.

Further, using the screen display shown in FIG. 7, the user can change or delete the data in the new version components. When the user selects a target component from the new version layout on the left side in the screen example, a present state of the selected component is displayed on the right upper portion in the screen example. Further, on the right lower portion in the screen example, only data of its component is displayed. In this screen example, the user performs change/deletion of the data. When the user selects an OK button, data after correction of its component is decided.

Further, in the screen example shown in FIG. 7, in case that there is a component which exists in only the new version document, its component is displayed on the layout showing the new version, distinguished from other components so that the user can notice its component. In the example shown in FIG. 7, its component is subjected to hatching, and actually displayed in color such as yellow semi-transparent color which the user can readily notice.

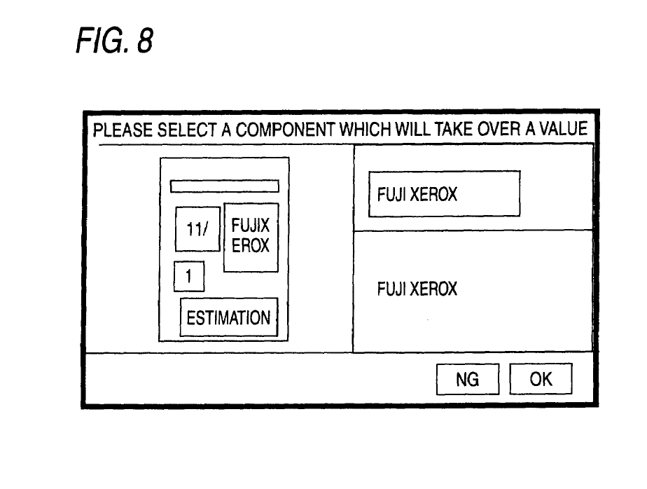

The user, in case that he selects this component, selects input of new data, or reflection of any component value in the old version. In case that the user selects the input, the display screen shifts to an input screen. Further, in case that the component value in the old version is reflected, the display screen shifts to a selection screen (refer to FIG. 8) of the old version components.

FIG. 8 is a diagram showing an example of a screen for the component selection from the old version. On the left side in this screen example, the layout of the old version component group is displayed. The user selects a component from the components in this layout. Hereby, a value of the selected component is reflected on the right side in the screen example. On the right upper portion, a state where a value is input in an actual component is displayed; and on the right lower portion, only the value of the selected component is displayed. The user can perform data change on this screen. When the user selects an OK button, the data of its selected component is taken over by the new version component.

The fixed-form management server 20 returns the fixed-form document of which the latest version has been updated to the multifunctional machine which the user has used, whereby its document can be printed on the multifunctional machine 10 side. Hereby, the user side can manage its fixed-form document as an original in a paper state.

### (Advantage of Implement)

In the embodiment, it is possible to realize internal control in computerization of a fixed-form document such as a ledger sheet. The invention can be applied to, for example, a collective decision-making system in an insurance operation, a school, or an office.

According to such the embodiment, forms other than the latest version form are not mixed on the work flow, and documents delivered to the inside/outside of the office can be unified. Further, since it is possible to ensure that the latest version fixed-form document is always used, it is not necessary for the user to always confirm whether the form to be input on the work flow is in the latest version. Further, even in case that the version of the fixed-form document is revised, and the sheet printed in the old version form is used as it is, handling in new version is possible on the sequential work flow, so that the printing matter in the old version does not become useless.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A fixed-form information management system comprising:
an image input unit that captures an image of a document;
a fixed-form recognition unit that recognizes a fixed-form type and an information structure of the document from the image captured by the image input unit;
a comparison unit that compares the information structure of the fixed-form type recognized by the fixed-form recognition unit with information structure of a fixed-form type corresponding to the recognized fixed-form type and registered in advance; and
a display unit that displays a result of the comparison by the comparison unit on a screen.

2. The fixed-form information management system as claimed in claim 1, further comprising:
a reception unit that receives an instruction from a user; and
an update unit that updates, in accordance with the instruction received by the reception unit, association between the information structure of the fixed-form type recognized by the fixed-form recognition unit and the information structure of the fixed-form type corresponding to the recognized fixed-form type and registered in advance.

3. The fixed-form information management system as claimed in claim 1,
wherein
the display unit displays the information structure of the fixed-form type recognized by the fixed-form recognition unit and the information structure of the fixed-form type corresponding to the recognized fixed-form type and registered in advance on the screen in a contrast state.

4. The fixed-form information management system as claimed in claim 1,
wherein
the display unit gives different display from display of other items to an item that has, in the comparison result by the comparison unit, a different point in the association between the information structure of the fixed-form type recognized by the fixed-form recognition unit and the information structure of the fixed-form type corresponding to the recognized fixed-form type and registered in advance.

5. The fixed-form information management system as claimed in claim 1,
wherein
the display unit, if it will display the information structure of the fixed-form type recognized by the fixed-form recognition unit as the comparison result, displays only an item having a different point in the association with the information structure of the fixed-form type corresponding to the recognized fixed-form type and registered in advance.

6. A fixed-form information managing method comprising:
capturing an image of a document;
recognizing a fixed-form type and an information structure of the document from the captured image;
comparing the information structure of the recognized fixed-form type with an information structure of a fixed-form type corresponding to the recognized fixed-form type and registered in advance; and
displaying a result of the comparison.

7. The fixed-form information managing method as claimed in claim 6, further comprising:
receiving an instruction from a user; and
updating, in accordance with the received instruction, the association between the information structure of the recognized fixed-form type and the information structure of the fixed-form type corresponding to the recognized fixed-form type and registered in advance.

8. The fixed-form information managing method as claimed in claim 6,
wherein
in the displaying of a result of the comparison, comprises displaying the information structure of the recognized fixed-form type and the information structure of the fixed-form type corresponding to the recognized fixed-form type and registered in advance are displayed in a contrast state.

9. The fixed-form information managing method as claimed in claim 6,
wherein
in the displaying of a result of the comparison, different display from display of other items is given to an item having a different point in the association between the information structure of the recognized fixed-form type and the information structure of the fixed-form type corresponding to the recognized fixed-form type and registered in advance.

10. The fixed-form information managing method as claimed in claim 6,
wherein
in the displaying of a result of the comparison, regarding display of the information structure of the recognized fixed-form type, only an item having a different point in the association with the information structure of the fixed-form type corresponding to the recognized fixed-form type and registered in advance is displayed.

11. A computer readable medium storing a program causing a computer to execute a process for managing fixed-form information, the process comprising:
capturing an image of a document;
recognizing a fixed-form type and an information structure of the document from the captured image;
comparing the information structure of the recognized fixed-form type with an information structure of a fixed-form type corresponding to the recognized fixed-form type and registered in advance; and
displaying a result of the comparison.

12. The computer readable medium as claimed in claim 11, further comprising:
receiving an instruction from a user; and
updating, in accordance with the received instruction, the association between the information structure of the recognized fixed-form type and the information structure of the fixed-form type corresponding to the recognized fixed-form type and registered in advance.

13. The computer readable medium as claimed in claim 11,
wherein
in the displaying of a result of the comparison, comprises displaying the information structure of the recognized fixed-form type and the information structure of the fixed-form type corresponding to the recognized fixed-form type and registered in advance are displayed in a contrast state.

14. The computer readable medium as claimed in claim 11,
wherein
in the displaying of a result of the comparison, different display from display of other items is given to an item having a different point in the association between the information structure of the recognized fixed-form type and the information structure of the fixed-form type corresponding to the recognized fixed-form type and registered in advance.

15. The computer readable medium as claimed in claim 11,
wherein
in the displaying of a result of the comparison, regarding display of the information structure of the recognized fixed-form type, only an item having a different point in the association with the information structure of the fixed-form type corresponding to the recognized fixed-form type and registered in advance is displayed.
